(19) United States
(12) Patent Application Publication
(10) Pub. No.: US 2005/0131759 A1
(43) Pub. Date: Jun. 16, 2005

(54) Targeting customers across multiple channels

(76) Inventors: Aseem Agrawal, Arlington, VA (US); Sunil Goyal, Gurgaon (IN); Ravi Kothari, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/734,793

(22) Filed: Dec. 12, 2003

(51) Int. Cl. G06F 17/60

(52) U.S. Cl. 705/14

(57) ABSTRACT

A customer request is received, and the channel type upon which it was made is identified. The customer making the request is also identified. A record of customer activity is available, and from this, a set of beliefs for the customer for the current channel is formed. The beliefs map to profile attributes. The beliefs are merged to form an integrated profile (i.e. for the same customer across all channels), and on this basis a customer targeting promotion is generated. The promotion is added to the response to the specific customer request and together these are sent to the customer.

### FIELD OF THE INVENTION

The present invention relates to targeting customers, and in one form to targeting customers who make a purchase request or enquiry using multiple channels, and servicing that request as well as providing a channel-specific promotion.

### BACKGROUND

There are millions of different transactions taking place on eCommerce sites every day. Merchants are offering products and services on more and more channels (e.g., mobile phones, PDAs, and conventional channels such as stores, direct mail catalogs, and online retail sites) to allow broader reach and customer convenience. A study conducted recently by the Boston Consulting Group and Forrester Research concluded that multi-channel shoppers spend more per visit, shop more frequently and generate 72 percent more revenue than shoppers who only shop one channel.

Most merchants have not been able to realize this potential because of a lack of seamless integration across various channels. Some merchants do offer a degree of integration by means of data replication across various channel systems, but not more than this. Often, that can result in different prices on different channels. Where merchants do offer the same prices on different channels, more often than not this is due to significant ‘manual’ effort, rather than automatic consistency across the channels.

A September 2001 Gartner Group report on customer relationship management states “An estimate of customer profitability, loyalty or product preference is infinitely more valuable than a list of product purchases and customer service requests.” It is thus clear that it is easier and cheaper to retain existing customers rather than to attract new ones. With more accurate insights into customer behavior and preferences, merchants can effectively attract and retain customers, and use marketing dollars where they are most likely to produce optimal results. Increased customer satisfaction also results in much needed referrals. This requires retailers to focus on knowing more about the customers and using that knowledge in each interaction.

US Patent Publication No. US2002-0087643A1, entitled Method and System for Providing Unified WAP Alerts (to Eric W Parsons, published on Jul. 4, 2002), describes a system for unified WAP and e-mail alerts. Alerts are sent to customers based on customer-defined criteria, e.g., if the price on chosen items is reduced.

International Patent Publication No. WO 01/41033A3, entitled Point-of-Sale Advertisement System (in the name E-POS! Marketing Company, published on Jun. 7, 2001), describes a system for POS advertising based on current and past transactions of a customer.

US Patent Publication No. U.S. 2002/0091562 A1, entitled Facilitating Off-line and Online Sales (to Brian M Seigel, published on Jul. 11, 2002), describes an arrangement where the profile and transactions of customers are recorded on a smart card.

U.S. Pat. No. 6,389,400 (Bushey et al, issued on May 14, 2002), entitled System and Methods for Intelligent Routing of Customer Requests Using Customer and Agent Models, describes a form of aggregate customer profile generation. The system of Bushey et al routes calls in a call center, based partly on modeling the customer and the agents. The customer model uses identification information, background information retrieved from the database and the task and attitude information.

These arrangements do not provide a solution to the need identified above. The challenge therefore, is that as merchants make more and more channels available to the consumer, uniform personalization and targeting across channels utilizing customer behavior on all channels becomes very important.

### SUMMARY

An objective is to offer consistent pricing, but differentiated promotions in a multi-sales channel environment. This involves establishing a dynamically updateable customer profile based on information gathered from multiple channels by a single host. The profile includes the personal attributes of customer behavior and interests.

A customer request is received, and the channel type upon which it was made is identified. The customer making the request is also identified. Based on customer activity, a set of beliefs for the customer, for each channel supported, is formed. The beliefs map to profile attributes. The beliefs are merged to form an integrated profile (i.e. for the customer across all channels), and on this basis a channel-specific promotion is generated. The promotion is added to the response to the specific customer request and together these are sent to the customer.

### DESCRIPTION OF DRAWINGS

FIG. 1 is a flow diagram of the general process for targeting customers.

FIG. 2 is a schematic diagram of a system for performing the process of FIG. 1.

FIG. 3 is a schematic representation of a computer system suitable for performing the techniques described with reference to FIGS. 1 and 2.

### DETAILED DESCRIPTION

Glossary of Terms

Channel Channels are the media through which a merchant reaches and interfaces with the customers. Examples of sales channels include a store (with or without POS), a telephone, a catalog, an online-PC, a mobile phone, PDAs, tablet PCs, direct marketing, and the like.
Customer Profile Customer profile is the encapsulation of customer behavior and interests.
Belief Beliefi results from uncertainty. Belief differs from knowledge because of the uncertainty arising for lack of information.
User State User State is identified by a set of variables and any other quantifiable measures.
Promotion Promotion is defined as any offering to customer, e.g., up-sell, cross-sell, discount, coupon, personalized content, advertisement, or any other such communication of offering. By implication, what is included is a decision to show or not show some/all product or services.
Overview

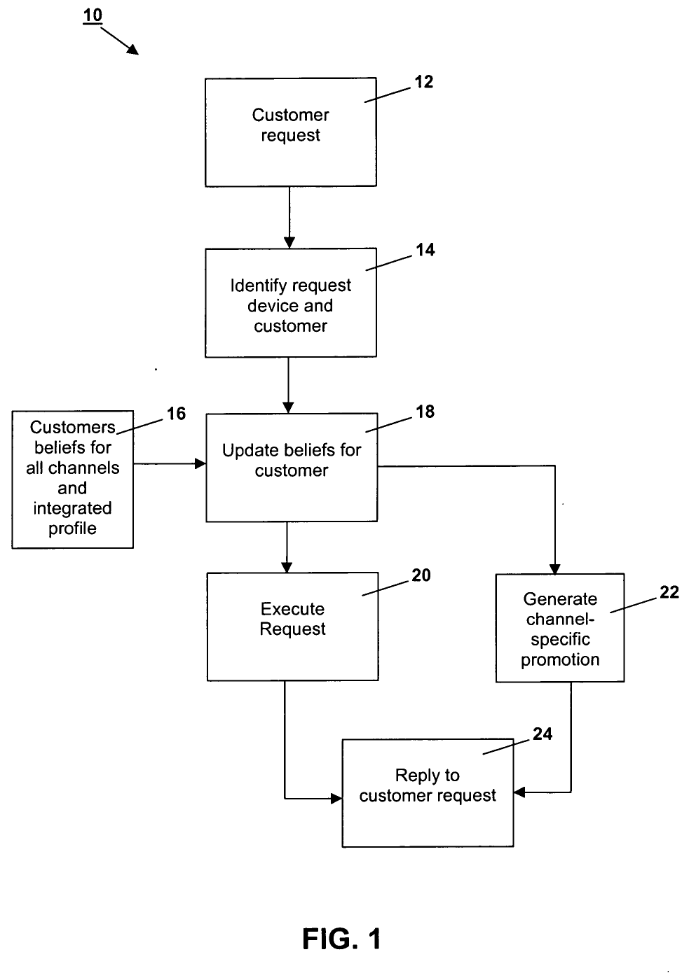

A process of targeting customers is now described, in a general sense, with reference to FIG. 1. A method 10 commences with a customer request 12 being passed to a processing system. The system identifies the requesting device (i.e. channel) and the customer (step 14). The system has a store of beliefs for a set of customers for all types of channel as well as an integrated belief profile (step 16). The channel specific belief profile and integrated belief profile for this customer is updated (step 18). The specific customer request (i.e. in the nature of an enquiry or an order for the purchase of goods or services) is then executed (step 20). In parallel, a channel-specific promotion is generated on the basis of updated beliefs for the customer (step 22). A reply is then sent in response to the customer request that includes the executed result as well as the channel-specific promotion (step 24).

### Embodiment

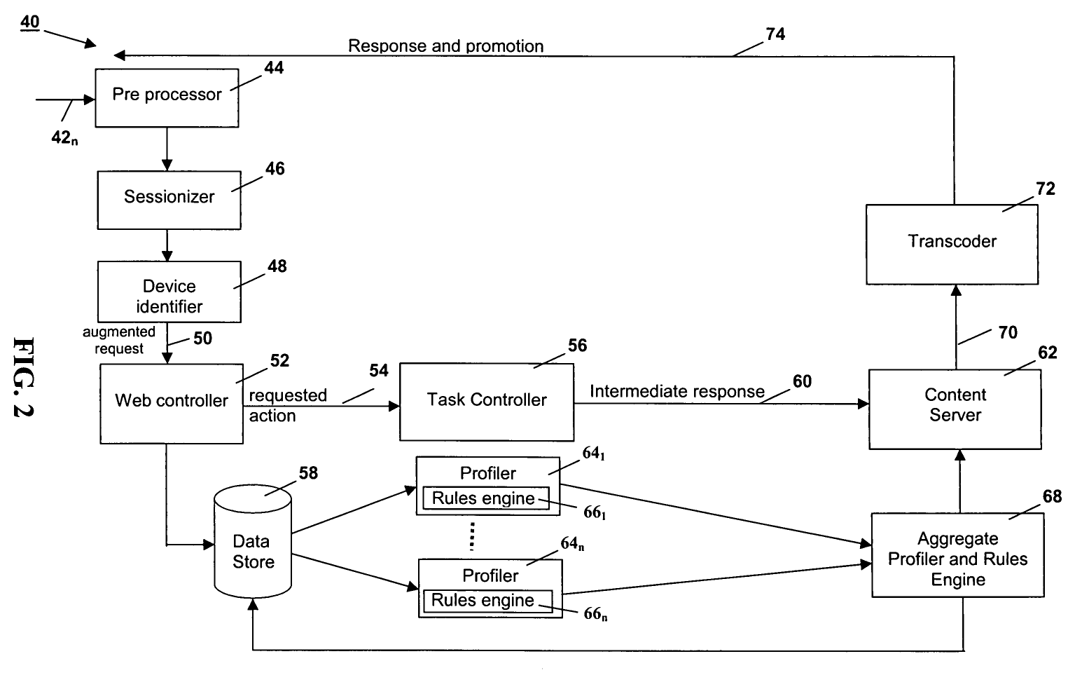

Referring now to FIG. 2, a system 40 for servicing a customer request will be described. A user request is made on a specific channel 42ₙ. The channels 42ₙ include many types of devices, such as PDAs, computers, and fixed and mobile telephones.

A request is processed by a pre-processor 44, which converts the channel-specific requests into a format that subsequently can be accommodated by the system 40. The pre-processor 44 thus requires circuits or coding that can convert any form of request format from the channels 42ₙ into a single format for further processing.

A re-formatted request is then passed to a sessionizer 46. The sessionizer 46 identifies the user, and maintains the user sessions spanning multiple requests. This is achieved by using one or more of (a) cookies, (b) URL encoding/rewriting, and (c) hidden field mechanisms. A user session usually spans multiple requests from the same user in a particular session.

The output from the sessionizer 46 passes to a device identifier 48 that acts to identify the requesting device. The device identifier 48 also augments the user request with this information. The augmented request 50 is then passed to a web controller 52. The web controller routes the user request for action to a task controller 56, and passes the click stream data to a data store 58 for persistent storage.

The task controller 56 acts on the requested action 54 by executing processes associated with it, and passes its output, representing the intermediate response 60 to a content server 62.

The data store 58 is accessed by a set of channel-specific profilers 64ₙ. The data extracted from the data store 58 includes user actions, demographics and transactions/click stream history. The profilers 64ₙ relate to the number of channels supported by the system 40, and for each channel there is an associated rules engine 66ₙ. The rules engines contain rules that are either explicitly defined by the merchant or obtained through use of collaborative filtering, association rule mining and other related techniques.

The channel profilers 64ₙ associate beliefs within the frame of discernment for the present user for the relevant channel. The beliefs formed on all channels for the same user are combined in an aggregate profiler 68 to form a consolidated set of beliefs for the present customer.

Amongst others, one approach for consolidation is based on Dempster Orthogonal Sum as given in the mathematical theory of belief functions by Dempster-Shafer. The Dempster-Shafer theory of belief function deals with making decisions under uncertainty (or lack of information), and provides a non-Bayesian way of using mathematical probability to quantify subjective judgments. A belief-function accesses probabilities for related questions and then considers the implications of these probabilities for the question of interest. Degree of belief obtained in this way may fail to add to 100% as the rule is based on the standard idea of probabilistic independence. The rule allows beginning with initial judgment and then renormalizes the probabilities of remaining possibilities, so they add to 100%. The net effect thus is tallying items of evidence reinforce each other and conflicting items of evidence erode each other.

Specific promotion/personalization for the current user is decided based on the channel-specific and integrated beliefs thus formed, possibly giving greater weightage to channel specific behavior and based on channel characteristics, using another set of rules, either pre-configured or specified by the merchant. These rules help generate channel-specific promotions to the customer based on the obtained single integrated customer profile (e.g., offer discount of 10% to ‘price-sensitive’ AND ‘likely to buy’ customer, who is visiting the site through a PDA).

Consider the following example for a shopper using two channels.

TABLE 1

| | Profile Attributes | | | | | | | |
|---|---|---|---|---|---|---|---|---|
| | PS | BS | RB | LB | TS | IM | MR | FV |
| Channel 1 | 0.25 | 0.05 | 0.00 | 0.00 | 0.00 | 0.50 | 0.10 | 0.10 |
| Profile | | | | | | | | |
| Channel 2 | 0.20 | 0.00 | 0.20 | 0.00 | 0.10 | 0.30 | 0.00 | 0.20 |
| Profile | | | | | | | | |
| Integrated | 0.23 | 0.00 | 0.00 | 0.00 | 0.00 | 0.68 | 0.00 | 0.09 |
| Profile | | | | | | | | |

The Profile Attributes are elements within a “frame of discernment” to which a belief value is associated. A belief value is between 0 and 1, and indicates the degree of confidence of happening of the profile attribute.

The attributes are:
PS—Price Sensitive
BS—Big Spender
RB—Recreational Browser
LB—Likely Buyer
TS—Techno Savvy
IM—Impulsive
MR—Market Initiative Responsive
FV—Frequent Visitor

The Integrated Profile is obtained by combining the channel 1 and channel 2 profiles, in the manner as follows:

1. From the Dempster Orthogonal sum (DOS) by orthogonally multiplying channel beliefs.

TABLE 2

| DOS | 0.25 | 0.05 | 0.00 | 0.00 | 0.00 | 0.50 | 0.10 | 0.10 |
|---|---|---|---|---|---|---|---|---|
| 0.20 | 0.05 | 0.10 | 0.00 | 0.00 | 0.00 | 010 | 0.02 | 0.02 |
| 0.00 | 0.00 | 0.00 | 0.00 | 0.00 | 0.00 | 0.00 | 0.00 | 0.00 |
| 0.20 | 0.05 | 0.01 | 0.00 | 0.00 | 0.00 | 0.10 | 0.02 | 0.02 |
| 0.00 | 0.00 | 0.00 | 0.00 | 0.00 | 0.00 | 0.00 | 0.00 | 0.00 |
| 0.10 | 0.03 | 0.01 | 0.00 | 0.00 | 0.00 | 0.05 | 0.01 | 0.01 |
| 0.30 | 0.08 | 0.02 | 0.00 | 0.00 | 0.00 | 0.15 | 0.03 | 0.03 |
| 0.00 | 0.00 | 0.00 | 0.00 | 0.00 | 0.00 | 0.00 | 0.00 | 0.00 |
| 0.20 | 0.05 | 0.01 | 0.00 | 0.00 | 0.00 | 0.10 | 0.02 | 0.02 |

The BPA are obtained from the DOS for corresponding attributes in the intersection of attributes (i.e. PS with PS, BS with BS, etc.):

TABLE 3

| | Profile Attributes | | | | | | | |
|---|---|---|---|---|---|---|---|---|
| | PS | BS | RB | LB | TS | IM | MR | FV |
| BPA | 0.05 | 0.00 | 0.00 | 0.00 | 0.000 | 0.15 | 0.00 | 0.02 |

A normalised BPA, which equals the Integrated Profile in Table 1 above, is obtained by normalising the BPA with the beliefs associated with null intersections.

In other words, 0.05-0.23, 0.15×0.68 and 0.02-0.09.

An example of the rules that can be applied to determining the specific promotion is: If the BPA IM attribute value is greater than 0.6 and the price of the item being browsed is more than $100.00, then offer a coupon of 10% rebate valid for 20 minutes. If, on the other hand, the shopper is using a mobile channel, then the time of validity may be 5 minutes.

The response 60 from the Task Controller 56 is then updated by the Content Server 62 based on customized promotion(s)/personalized content obtained from Aggregate Profiler 68.

The response and promotion 70 output of the content server 62 then flows to a Transcoder 72 which converts the output to the channel-specific format and forwards the resultant response and promotion 74 to the user.

Computer Hardware and Software

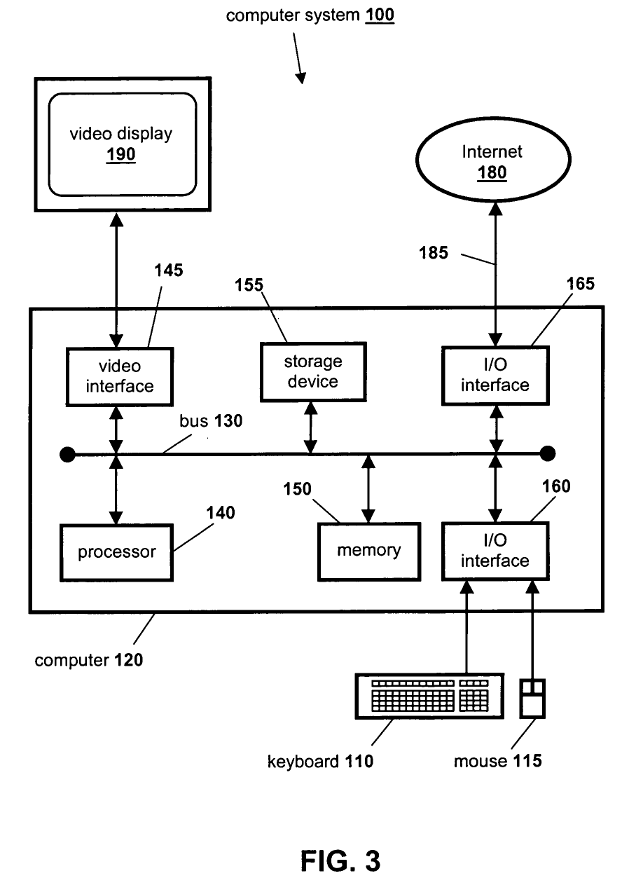

FIG. 3 is a schematic representation of a computer system 100 that can be used to implement the techniques described herein. Computer software executes under a suitable operating system installed on the computer system 100 to assist in performing the described techniques. This computer software is programmed using any suitable computer programming language, and may be thought of as comprising various software code means for achieving particular steps.

The components of the computer system 100 include a computer 120, a keyboard 110 and mouse 115, and a video display 190. The computer 120 includes a processor 140, a memory 150, input/output (I/O) interfaces 160, 165, a video interface 145, and a storage device 155.

The processor 140 is a central processing unit (CPU) that executes the operating system and the computer software executing under the operating system. The memory 150 includes random access memory (RAM) and read-only memory (ROM), and is used under direction of the processor 140.

The video interface 145 is connected to video display 190 and provides video signals for display on the video display 190. User input to operate the computer 120 is provided from the keyboard 110 and mouse 115. The storage device 155 can include a disk drive or any other suitable storage medium.

Each of the components of the computer 120 is connected to an internal bus 130 that includes data, address, and control buses, to allow components of the computer 120 to communicate with each other via the bus 130.

The computer system 100 can be connected to one or more other similar computers via a input/output (I/O) interface 165 using a communication channel 185 to a network, represented as the Internet 180. The computer system 100 can take an input request from another system using the Internet 180 using the communication channel 185 and can also send back the response to another system using the Internet 180.

The computer software may be recorded on a portable storage medium, in which case, the computer software program is accessed by the computer system 100 from the storage device 155. Alternatively, the computer software can be accessed directly from the Internet 180 by the computer 120. In either case, a user can interact with the computer system 100 using the keyboard 110 and mouse 115 to operate the programmed computer software executing on the computer 120.

Other configurations or types of computer systems can be equally well used to implement the described techniques. The computer system 100 described above is described only as an example of a particular type of system suitable for implementing the described techniques.

### Other Embodiments

The Rules engines 66ₙ can be configured to draw on contemporaneous or fully historical customer data from the data store 58. The Rules engines can also draw on data from a demographic group that a particular user belongs to.

In a similar way, the Aggregate profiler 68 can combine the profiles formed on all channels for a customer segment, rather than an individual customer.

### Conclusion

Various alterations and modifications can be made to the techniques and arrangements described herein, as would be apparent to one skilled in the relevant art.

1. A method for targeting customers comprising the steps of:
receiving a customer request on a channel;
forming an integrated belief profile for said requesting customer for a set of channel types;
executing said request to give a response;
generating a promotion on the basis of said integrated belief profile; and
providing said response and said promotion to said requesting customer.

2. The method of claim 1, comprising the further step of identifying the customer making the request, and wherein said step of forming an integrated belief profile includes:
generating a set of beliefs for said customer for said set of channels; and
generating said integrated belief profile from a respective said set of beliefs.

3. The method of claim 2, wherein a normalized Dempster Orthogonal Sum of said set of beliefs is formed to give said integrated belief profile.

4. The method of claim 1, wherein said promotion is generated according to a set of predetermined rules.

5. The method of claim 2, wherein the step of generating a promotion is also based on said customer beliefs for the respective channel.

6. The method of claim 1, further comprising the step of identifying the channel upon which the request is made, and wherein said response and said promotion is provided on said identified channel type.

7. The method of claim 1, wherein said receiving step further includes converting a format of the requesting channel to a common format, and wherein said providing step back-converts said response and said promotion to the format of the customer request.

8. The method of claim 1, comprising the further step of accumulating said set of beliefs for customers over multiple user sessions such that said integrated belief profile is incrementally updated.

9. A data processing system for targeting customers comprising:
an interface for receiving a customer request on a channel;
a data processor for forming an integrated belief profile for said requesting customer for a set of channel types, executing said request to give a response, and generating a promotion on the basis of said integrated belief profile; and
wherein said interface provides said response and said promotion to said requesting customer.

10. The data processing system of claim 9, wherein said processor identifies the customer making the request, and generates a set of beliefs for said customer for said set of channels, and generates said integrated belief profile from a respective said set of beliefs.

11. The data processing system of claim 10, wherein said processor calculates a normalized Dempster Orthogonal Sum of said set of beliefs to give said integrated belief profile.

12. The data processing system of claim 11, wherein said processor generates said promotion according to a set of predetermined rules stored in a memory.

13. The data processing system of claim 10, wherein said processor generates a promotion also based on said customer beliefs for the respective channel.

14. The data processing system of claim 9, wherein said processor further identifies the channel upon which the request is made, and wherein said response and said promotion is provided by said interface on said identified channel type.

15. The data processing system of claim 9, wherein said interface converts format of the requesting channel to a common format, and back-converts said response and said promotion to the format of the customer request.

16. The data processing system of claim 9, further comprising a memory for accumulating said set of beliefs for customers over multiple user sessions such that said integrated belief profile is incrementally updated.

17. A computer program product for targeting customers, comprising a computer program held on a storage medium, the computer program including:
a code element for receiving a customer request on a channel;
a code element for forming an integrated belief profile for said requesting customer for a set of channel types;
a code element for executing said request to give a response;
a code element for generating a promotion on the basis of said integrated belief profile; and
a code element for providing said response and said promotion to said requesting customer.
